(19) United States
(12) Patent Application Publication
(10) Pub. No.: US 2016/0146089 A1
(43) Pub. Date: May 26, 2016

(54) COMPRESSOR COOLING

(71) Applicant: ROLLS-ROYCE PLC, London (GB)

(72) Inventor: Ivan POPOVIC, Derby (GB)

(21) Appl. No.: 14/928,363

(22) Filed: Oct. 30, 2015

(30) Foreign Application Priority Data
Nov. 26, 2014 (GB) 1420966.2

(51) Int. Cl. F01P 5/06; F02C 9/18; F01P 1/06

(52) U.S. Cl. CPC F01P 5/06; F01P 1/06; F02C 9/18

(57) ABSTRACT

A cooling arrangement for a compressor drive cone (48) in a gas turbine engine (10). An annular cavity (62) defined by the drive cone (48), a portion of a compressor rotor disc (44) and a downstream cavity wall (52). The cavity (62) comprising a recirculation zone (66) at its radially outermost region. The cavity (62) arranged to ingest hot working gas radially inwardly into the recirculation zone (66). An annular array of pipes (70) that penetrate through the cavity wall (52) close to the radially inward extent of the recirculation zone (66). The pipes (70) coupled to a supply of cooling fluid and having an open end arranged to direct the cooling air, in use, across the recirculation zone (66) towards the drive cone (48).

The present invention relates to a cooling system for a compressor drive cone of a gas turbine engine.

A compressor of a gas turbine engine comprises one or more rotating stages that are axially joined together. For example the compressor may include a drum with axially spaced annular arrays of rotor blades attached to it. The rotating stages are rotated by connection to a compressor drive cone, which itself is connected via an axial shaft to the driving turbine. The drive cone is frustoconical about the engine axis and has maximum radial extent at its most upstream end, where it is connected to the compressor drum or disc, and minimum radial extent at its most downstream end, where it is connected to the shaft.

A wall is located downstream of the drive cone. The wall and drive cone together form a cavity or passage. Hot gas from the exit of the final compressor rotor is ingested into the passage and directed along the passage towards the turbine. Since it is cool relative to the turbine it may be used to cool the turbine disc and/or blades. It may also be used to seal the rim between the static structure and the rotating turbine blade root.

In recent years the temperature of the gas which exits from the final compressor rotor stage has increased. Thus the gas ingested into the passage is hotter in more modern gas turbine engines. One disadvantage of conventional arrangements is that the hot ingested gas tends to impinge directly on the compressor drive cone. It is therefore necessary either to provide a drive cone comprised of more heat-resistant material or with a heat-resistant coating, both of which are expensive, or to supply additional cooling to the drive cone.

The present invention provides a cooling system that seeks to address the aforementioned problems.

Accordingly the present invention provides a cooling arrangement for a compressor drive cone in a gas turbine engine, the arrangement comprising:
an annular cavity defined by the drive cone, a portion of a compressor rotor disc and a downstream cavity wall; the cavity comprising a recirculation zone at its radially outermost region; the cavity arranged to ingest hot working gas radially inwardly into the recirculation zone; and
an annular array of pipes that penetrate through the cavity wall close to the radially inner extent of the recirculation zone; each pipe (70) in the array of pipes (70) comprises a pipe extension (78) that penetrates into the recirculation zone (66) towards the drive cone (48) and rotor disc (44); the pipes coupled to a supply of cooling fluid and having an open end arranged to direct the cooling air, in use, across the recirculation zone towards the drive cone.

Advantageously the cooling arrangement provides better cooling but uses a smaller quantity of cooling fluid. Advantageously the cooling arrangement minimises egress of cooling fluid into the gas path through the compressor.

Each pipe in the array of pipes may be angled in a radial plane through the gas turbine engine. Each pipe in the array of pipes may be angled relative to a radial plane through the gas turbine engine in the direction of rotation of the compressor drive cone. Advantageously such angling of the pipes promotes swirl of the cooling fluid. Advantageously the fluid is delivered as a coherent jet across a greater distance.

Each pipe in the array of pipes may comprise a pipe extension that penetrates into the recirculation zone towards the drive cone and rotor disc. Advantageously this may improve the penetration of the cooling fluid towards the drive cone and/or rotor disc.

There may be an annular fin located at the radially outer, axially forward corner of the recirculation zone. Advantageously the fin promotes recirculation. The fin may be radiused on its surface facing the recirculation zone. Advantageously this promotes addition turning of the flow from substantially radial to substantially axial.

There may be a seal adjacent to the fin. The seal may control ingress of hot working gas. The seal may lower the pressure in the cavity to allow a higher pressure ratio across the pipes. Advantageously a higher pressure ratio across the pipes imparts more swirl to the cooling fluid.

There may be a source of cooling fluid. The source may be any of the group comprising: compressor delivery off-take; compressor bleed; bypass duct; a diffuser zone. There may be a pressure booster between the source and the pipes to increase the pressure of the cooling fluid. There may be temperature conditioning between the source and the pipes to lower the temperature of the cooling fluid. The cooling fluid may be temperature conditioned by the addition of water. There may be a heat exchanger arranged to cool cooling fluid that is supplied to the pipes. The heat exchanger may be in addition to a pressure booster and/or other temperature conditioning.

Each pipe may terminate with or as an aperture in the cavity wall. The aperture may be circular, oval, rectangular or an arc of an annulus.

Each pipe may be tapered so that it has a smaller cross-sectional area at the aperture than at its other end. For example its diameter at the aperture may be smaller than its diameter at the other end of the pipe.

The present invention also provides a compressor comprising the cooling arrangement as described; a gas turbine engine comprising the cooling arrangement as described; and a gas turbine engine comprising the compressor as described.

The scope of the invention includes the essential features. Any combination of the optional features is encompassed within the scope of the invention except where mutually exclusive.

The present invention will be more fully described by way of example with reference to the accompanying drawings, in which:

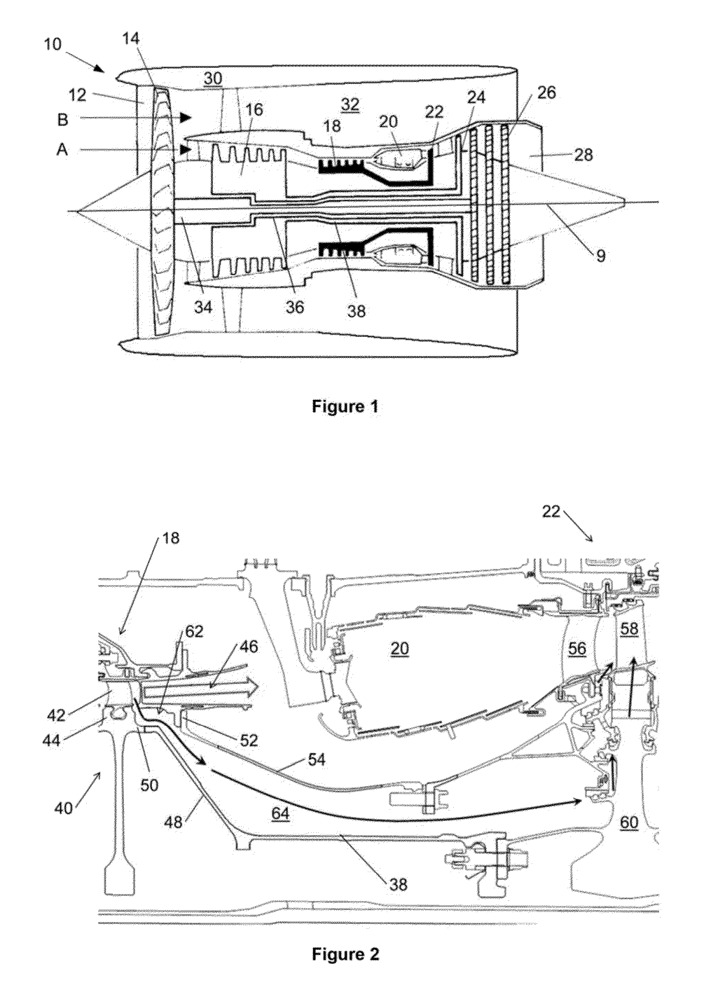

FIG. 1 is a sectional side view of a gas turbine engine.

FIG. 2 is a schematic enlargement of part of the gas turbine engine shown in FIG. 1.

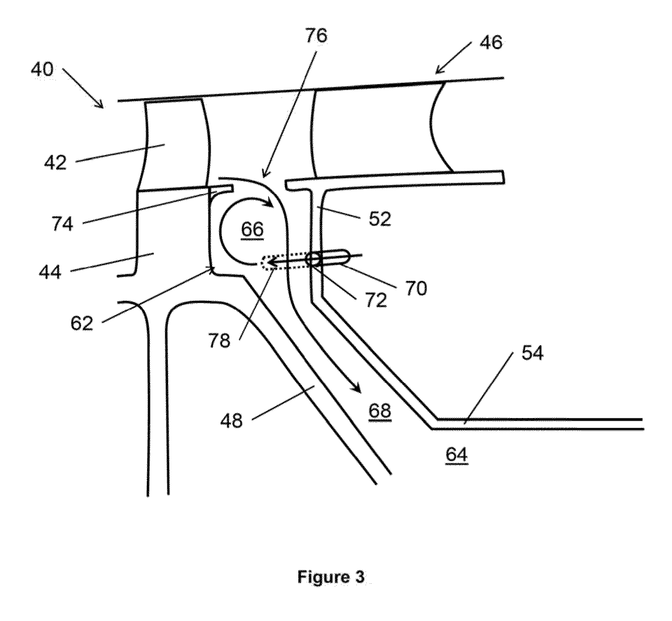

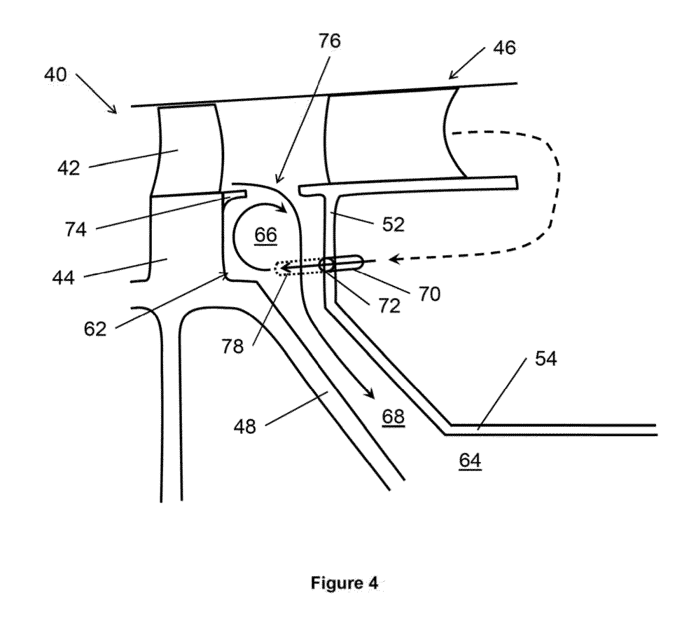

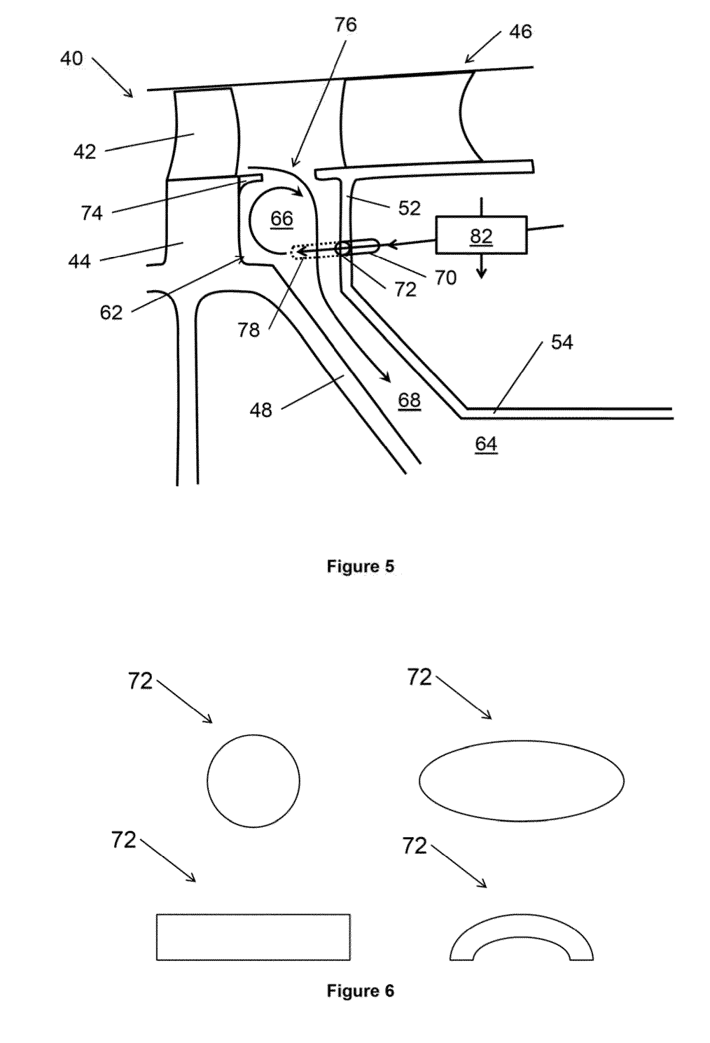

FIG. 3, FIG. 4 and FIG. 5 are further schematic enlargements of part of the gas turbine engine according to the present invention.

FIG. 6 is a schematic representation of aperture shapes.

A gas turbine engine 10 is shown in FIG. 1 and comprises an air intake 12 and a propulsive fan 14 that generates two airflows A and B. The gas turbine engine 10 comprises, in axial flow A, an intermediate pressure compressor 16, a high pressure compressor 18, a combustor 20, a high pressure turbine 22, an intermediate pressure turbine 24, a low pressure turbine 26 and an exhaust nozzle 28. A nacelle 30 surrounds the gas turbine engine 10 and defines, in axial flow B, a bypass duct 32. A low pressure shaft 34 connects the low pressure turbine 26 to the fan 14 in order to drive the rotation. An intermediate pressure shaft 36 connects the intermediate pressure turbine 24 to the intermediate pressure compressor 16 in order to drive its rotation. A high pressure shaft 38 connects the high pressure turbine 22 to the high pressure compressor 18 in order to drive its rotation.

In use, air is drawn into the air intake 12 and is accelerated by the fan 14. It is split into the two axial flows A, B. In a high bypass ratio gas turbine engine, the majority of the air is passed through the bypass duct 32 to be expelled to give propulsive thrust. The remainder of the air is passed into the core engine (axial flow A) where it is compressed and accelerated by the intermediate pressure compressor 16 and then the high pressure compressor 18. Fuel is injected into the combustor 20 and combusted with the air from the high pressure compressor 18. Hot combustion gases are expelled from the combustor 20. The gases are expanded and slowed through the high pressure turbine 22, intermediate pressure turbine 24 and finally through the low pressure turbine 26 before being expelled through the exhaust nozzle 28 to provide a small amount of the propulsive thrust.

FIG. 2 shows an enlargement of the high pressure systems of the gas turbine engine 10. Thus the end of the high pressure compressor 18, the high pressure shaft 38 and the high pressure turbine 22 are shown. The combustor 20 is also shown.

The high pressure compressor 18 is formed of a plurality of alternating rotating and stationary stages. Each stationary stage is formed of an annular array of stator vanes mounted from the casing surrounding the high pressure compressor 18. Each rotating stage is formed of an annular array of rotor blades mounted on a disc, ring or drum. The final rotor stage 40 of the high pressure compressor 18 is shown in FIG. 2. It comprises an annular array of rotor blades 42, of which one is shown, and a rotor disc 44 to which the blades 42 are mounted. Downstream of the rotor blades 42 is a diffusion zone 46 in which the compressed hot gases are slowed before they are delivered to the combustor 20.

The rotation of the rotor disc 44 is driven by the high pressure turbine 22. The drive is transmitted through the high pressure shaft 38 which is coupled to the rotor disc 44 of the final rotor stage 40 by a drive cone 48. The drive cone 48 may be integral with the high pressure shaft 38 or may be connected to it in a releasable or permanent manner. The drive cone 48 is frustoconical with its minimum diameter at its join with the high pressure shaft 38 and its maximum diameter where it is coupled to the rotor disc 44.

The rotor disc 44 includes an annular flange 50 radially inwardly of the position where the rotor blades 42 are mounted to the rotor disc 44. This flange 50 is replaced by the drum surface where the high pressure compressor 18 has a drum not a plurality of discs or rings. The annular flanges 50 between rotor stages abut or are connected together to form a continuous annular surface. The annular flange 50 extending rearwardly, in the direction of gas flow through the gas turbine engine 10, is the part of the rotor disc 44 that is coupled to the drive cone 38. The drive cone 38 may include a similar flange at its forward end.

Rearwards of the rotor disc 44 is a cavity wall 52 that extends radially inwards from the diffusion zone 46. The cavity wall 52 will be described in more detail with respect to FIG. 3. The cavity wall 52 is integral with or connected to annular static structure 54 that extends generally parallel to the rotational axis 9 of the gas turbine engine 10. Thus the cavity wall 52 is static; it does not rotate. The static structure 54 is coupled at its rearward, downstream end to the radially inner features of an array of nozzle guide vanes 56 that receive hot combustion gases from the combustor 20 and direct them to the rotor blades 58 of the high pressure turbine 22. The rotor blades 58 are mounted to a turbine disc 60 which is connected to the high pressure shaft 38 to drive the rotation thereof.

An annular cavity 62 is formed in the axial space between the rotor disc 44 of the high pressure compressor 18, the drive cone 48 and the cavity wall 52. The annular cavity 62 is thus radially inwardly of the gas path through the core of the gas turbine engine 10 which includes the compressor rotor blades 42 and diffusion zone 46. Some of the compressed working fluid that exits the rotor blades 42 to be delivered into the diffusion zone 46 is ingested into the cavity 62 and thence directed along an annular passage 64. The passage 64 extends axially and is bounded between the high pressure shaft 38 and the static structure 54 which is located radially outwards of the high pressure shaft 38.

Since the air ingested from the exit of the high pressure compressor 18 is relatively cool it is used to cool the turbine disc 60, predominantly by impingement of the air at the downstream end of the passage 64. It is also used to cool the turbine rotor blades 58 in known manner. The ingested air that is delivered to the high pressure turbine 22 along the passage 64 is also used for rim sealing of the radially inner surface between the nozzle guide vanes 56 and the rotor blades 58. These uses of the ingested air are illustrated in FIG. 2 by black arrows.

FIG. 3 is a further schematic enlargement of the cavity 62 and surrounding components. The cavity 62 is formed of two zones: the radially outer zone is a recirculation zone 66 and there is an expulsion zone 68 which is radially inwards of the recirculation zone 66. The expulsion zone 68 is bounded by the drive cone 48 and an angled portion of the cavity wall 52. As will be apparent, the drive cone 48 extends radially inwardly and axially rearward to make an angle with the radial direction (vertically up the page as drawn) of approximately 55°. The angled portion of the cavity wall 52 is approximately parallel to the drive cone 48 so that the expulsion zone 68 is an elongate passage in cross-section.

The cavity wall 52 extends approximately radially between the diffusion zone 46 and its angled portion. It is therefore approximately parallel to the rotor disc 44 above the annular flange 50. The recirculation zone 66 is bounded at its radially outer extent by a surface formed at the interface between the rotor blades 42 and the rotor disc 44 and the diffusion zone 46 inner surface. The radially inner extent of the recirculation zone 66 is defined by the annular flange 50 of the rotor disc 44 and the drive cone 48 and the open interface between the recirculation zone 66 and the expulsion zone 68. The cavity wall 52 may be located axially forward of the equivalent component in known arrangements because it is not necessary to space the ingested gases from the rotor disc 44 due to the cooling system of the present invention, as will be explained below.

Some of the compressed working gas that exits the rotor blades 42 of the high pressure compressor 18 is ingested into the recirculation zone 66 of the cavity 62 and is then expelled into the expulsion zone 68. It travels through the expulsion zone 68 into the passage 64 and is thence delivered to the high pressure turbine 22.

A plurality of pipes 70 are provided as an annular array. Each pipe 70 is arranged to penetrate through the cavity wall 62 at the radially inward extent of the recirculation zone 66. Thus the pipe 70 penetrates through the radially extending portion of the cavity wall 52 close to the join with the angled portion. The pipe 70 may penetrate just through the cavity wall 52 so that its end is an orifice or aperture 72 that is flush in the upstream surface of the cavity wall 52. The pipes 70 may be the same length as the thickness of the cavity wall 52, in which case they may be considered as holes in the cavity wall 52. The other end of each pipe 70 is coupled to a supply of cooling fluid. The cooling fluid may be air. For example, the supply of cooling fluid may be extracted from the diffusion zone 46. Alternatively the cooling fluid may be extracted from an earlier compressor stage or the bypass duct 32, with suitable pressure-boosting. Alternatively the cooling fluid may be water, water mixed with air, or another fluid. Each pipe 70 may be individually coupled to the cooling air source or the pipes 70 may be coupled together and fed from the supply together.

The pipes 70 are directed axially forwards through the cavity wall 52 so that the end of the pipes 70 that is coupled to the supply of cooling fluid is downstream of the end of the pipes 70 that opens into the recirculation zone 66 of the cavity 62. The pipes 70 may be angled radially inwardly by a small amount, for example making an angle of a few degrees to the rotational axis 9 of the gas turbine engine 10. The pipes 70 act to pre-swirl the cooling fluid.

In use the pipes 70 receive cooling fluid and direct it into and across the recirculation zone 66 towards the drive cone 48. In particular, the pipes 70 direct the cooling fluid towards the interface between the drive cone 48 and the rotor disc 44. Recirculation of fluid in the recirculation zone 66 acts to convey the cooling fluid from the pipes 70 to the drive cone 48 and rotor disc 44. The rotation of the rotor disc 44 and drive cone 48 causes the cooling fluid to be pumped radially outwardly along the radial surface of the rotor disc 44 towards the rotor blades 42. The cooling fluid therefore forms a film to cool the drive cone 48 and rotor disc 44 in this region. As the cooling fluid reaches the radially outward extent of the recirculation zone 66 it interacts with the hot gases ingested from the exit of the rotor blades 42. Thus the cooling fluid is turned axially rearwards and then radially inwards and mixes with the hot ingested gases, thereby reducing the temperature of the ingested gases. The mixed air then travels approximately radially inwards through the downstream portion of the recirculation zone 66 and is delivered into the expulsion zone 68.

Optionally there may be an annular fin 74 provided at the axially forward, radially outer corner of the recirculation zone 66, where the rotor blade 42 blends into the blade root. The annular fin 74 preferably has a radiused surface towards the recirculation zone 66 in order to promote the change of direction of the cooling fluid from radially outwards to axially rearwards. Thus the optional fin 74 assists in recirculating the cooling fluid around the recirculation zone 66. The axial extent of the fin 74 also controls the axial gap 76 through which the hot working gas is ingested into the cavity 62.

The pipes 70 are dimensioned suitably, and are supplied with cooling fluid at a sufficient pressure, that the cooling air ejected therefrom has sufficient momentum to penetrate through the curtain of mixed air travelling radially inwards through the recirculation zone 66 to the expulsion zone 68. The jets of cooling air ejected from the pipes 70 must have sufficient velocity to impact the drive cone 48 and rotor disc 44 to cool them, and to be turned to pump radially outwards rather than be dispersed.

Optionally some or all of the pipes 70 may extend into the recirculation zone 66, as shown by pipe extension 78. The pipe extension 78 isolates the cooling air from the curtain of mixed cooling air and hot ingested gases travelling radially through the recirculation zone 66. It also reduces the distance that the cooling air is required to travel across the recirculation zone 66 in order to impact the drive cone 48 and rotor disc 44.

Optionally the pipes 70 may be angled in the circumferential direction in the same direction as the rotation of the rotor stage 40 and drive cone 48. This promotes swirling of the cooling air so that it remains as a discrete jet as it crosses the recirculation zone 66. Advantageously, by angling the pipes 70 the jets of cooling air are ejected substantially perpendicular to the mixed air flow from the axial gap 76 through the recirculation zone 66 to the expulsion zone 68. The jets penetrate through the mixed air flow better when they are substantially perpendicular to the mixed air flow.

Advantageously, because the pipes 70 focus the jets of cooling air the required mass flow through the pipes 70 is low. Particularly, the mass flow through the pipes 70 must be less than the mass flow into the expulsion zone 68 of the cavity 62. Thus the amount of cooling air required is lower than in known arrangements.

FIG. 4 is similar to FIG. 3 but shows schematically the cooling air being sourced. Thus the cooling air is extracted from the diffusion zone 46 at a mid-height of the outlet guide vanes 80. The outlet guide vanes 80 are static vanes which direct the working gases through the diffusion zone 46. Air passing over the mid-height of the outlet guide vanes 80 is cooler than air passing along the edges of the passage forming the diffusion zone 46 because the radially inner and outer walls of the diffusion zone 46 cause boundary layers which retard flow past them and therefore cause local heating. Thus it is beneficial to extract air from the mid-height of the outlet guide vanes 80 and to deliver it to the pipes 70 for cooling of the drive cone 48 and rotor disc 44, and to recirculate around the recirculation zone 66 to mix with the ingested hot working gases before delivery into the expulsion zone 68.

Advantageously the air drawn into the recirculation zone 66 through the axial gap 76 has low momentum because it is taken from the boundary layer of the flow exiting the rotor blades 42. Additionally the arrangement prevents cooling fluid being ejected from the cavity 62 towards the diffusion zone 46. Thus the performance of the diffusion zone 46 is protected.

Optionally there may be a heat exchanger 82 between the source of the cooling air and the pipes 70, as shown in FIG. 5. The heat exchanger 82 is supplied with cold fluid, for example air from the bypass duct 32 or uncombusted fuel from the fuel tanks. Thus the heat exchanger 82 acts to cool the cooling air before it is passed to the pipes 70. The cooled cooling air is more effective at cooling the drive cone 48 and rotor disc 44 and therefore less cooled cooling air is required to achieve the same level of cooling, or a greater temperature drop can be achieved with the same amount of cooling air.

The pipes 70 may be tapered so that the aperture 72 has a smaller diameter than the other end of each pipe 70. This would have the effect of accelerating the cooling flow so that it is better able to penetrate through the ingested air to reach the drive cone 48 and rotor disc 44.

The array of pipes 70 may include from ten to one hundred pipes 70 spaced equally around the annular cavity wall 52, for a high bypass ratio gas turbine engine 10. Preferably all the pipes 70 are directed at the same angle to the axial and/or radial planes. This has the advantage that there will be uniform cooling of the drive cone 48 and rotor disc 44, which are generally symmetrical about the rotational axis 9 of the gas turbine engine 10. However, in some applications it may be beneficial for some of the pipes 70 in the array to be angled differently to other pipes 70 in the array, for example to promote cooling of a vulnerable portion of the drive cone 48 and/or rotor disc 44. Similarly the pipes 70 may all have the same internal diameter and therefore eject the same mass flow rate.

The apertures 72 at the end of the pipes 70, either in the cavity wall 52 or at the end of the pipe extensions 78, may be shaped. Some exemplary shapes for the apertures 72 are shown in FIG. 6. In the simplest arrangement the apertures 72 are circular and the pipes are cylindrical. Alternatively the apertures may be oval or rectangular. The apertures 72 may be shaped as an arc of an annulus. Where the apertures 72 have a non-unity aspect ratio, the shorter axis is preferably aligned with radially. The pipes 70 may have the same cross-sectional shape as the aperture 72 or may be cylindrical and have a portion that transitions to the shape of the aperture 72.

The axial gap 76 through which hot working gases are ingested into the cavity 62 may be reduced by providing a seal. Consequently the pressure in the recirculation zone 66 of the cavity 62 is reduced and so the pressure ratio across the apertures 72 of the pipes 70 is lowered. This results in lower temperatures in the cavity 62 and therefore lower material temperatures for the drive cone 48 and rotor disc 44. Thus less cooling flow is required from the pipes 70.

The cooling arrangement has been described with respect to the rear stage 40 of the high pressure compressor 18. However, it is also applicable to cooling a drive cone 48 and rotor disc 44 of other stages of the high pressure compressor 18, or the intermediate pressure compressor 16, or a booster compressor. For example, a compressor may have a drive cone 48 that couples to an intermediate rotor stage. The cavity wall 52 in this example may be either a stationary component extending from a static component, for example from stator vanes between rotor blades 42, or may be a rotating wall coupled to the next rotating stage.

The cooling arrangement of the present invention is applicable to cooling the compressor drive cone 48 and rotor disc 44 of a two-shaft or three-shaft gas turbine engine 10. Such a gas turbine engine 10 may be used to power an aircraft, a ship or for industrial applications such as gas pumping and land-based power supply.

1. A cooling arrangement for a compressor drive cone in a gas turbine engine, the arrangement comprising:
an annular cavity defined by the drive cone, a portion of a compressor rotor disc and a downstream cavity wall; the cavity comprising a recirculation zone at its radially outermost region; the cavity arranged to ingest hot working gas radially inwardly into the recirculation zone; and
an annular array of pipes that penetrate through the cavity wall close to the radially inward extent of the recirculation zone; each pipe in the array of pipes comprises a pipe extension that penetrates into the recirculation zone towards the drive cone and rotor disc; the pipes coupled to a supply of cooling fluid and having an open end arranged to direct the cooling air, in use, across the recirculation zone towards the drive cone.

2. A cooling arrangement as claimed in claim 1 wherein each pipe in the array of pipes is angled in a radial plane through the gas turbine engine.

3. A cooling arrangement as claimed in claim 1 wherein each pipe in the array of pipes is angled relative to a radial plane through the gas turbine engine in the direction of rotation of the compressor drive cone.

4. A cooling arrangement as claimed in claim 1 further comprising an annular fin located at the radially outer, axially forward corner of the recirculation zone to promote recirculation.

5. A cooling arrangement as claimed in claim 4 wherein the fin is radiused on its surface facing the recirculation zone.

6. A cooling arrangement as claimed in claim 4 further comprising a seal adjacent to the fin to control ingress of hot working gas.

7. A cooling arrangement as claimed in claim 1 further comprising a source of cooling fluid, wherein the source is any of the group comprising: compressor delivery off-take; compressor bleed; bypass duct; a diffuser zone.

8. A cooling arrangement as claimed in claim 1 further comprising a heat exchanger arranged to cool cooling fluid that is supplied to the pipes.

9. A cooling arrangement as claimed in claim 1 wherein each pipe terminates with an aperture in the cavity wall.

10. A cooling arrangement as claimed in claim 1 wherein each pipe extension terminates with an aperture in the cavity wall.

11. A cooling arrangement as claimed in claim 9 wherein the aperture is circular, oval, rectangular or an arc of an annulus.

12. A compressor comprising the cooling arrangement as claimed claim 1.

13. A gas turbine engine comprising the cooling arrangement as claimed in claim 1.

14. A gas turbine engine comprising the compressor as claimed in claim 12.
